(19) United States
(12) Patent Application Publication
(10) Pub. No.: US 2025/0384793 A1
(43) Pub. Date: Dec. 18, 2025

(54) Cardiac Defect Model

(71) Applicant: University of South Carolina, Columbia, SC (US)

(72) Inventors: Stephanie Li Schaller, Columbia, SC (US); Katherine K. Chappell, Irmo, SC (US); Lonnie Rosier, Columbia, SC (US); Teresa Bowers, Columbia, SC (US)

(21) Appl. No.: 19/198,845

(22) Filed: May 5, 2025

Related U.S. Application Data
(60) Provisional application No. 63/659,448, filed on Jun. 13, 2024.

(51) Int. Cl. G09B 23/34

(52) U.S. Cl. CPC G09B 23/34

(57) ABSTRACT

A cardiac defect model that can be used for training and instruction purposes is provided. The cardiac defect model includes a base that includes an aorta, a pulmonary artery, a left atrium, a right atrium, a left ventricle, and a right ventricle. The cardiac defect model also includes a plurality of cavities. Each cavity is configured to receive a normal cardiac component insert and a defective cardiac component insert. Further, the normal cardiac component insert and the defective cardiac component insert are interchangeable.

### CROSS-REFERENCE TO RELATED APPLICATIONS

The present application claims the benefit of U.S. Provisional Application No. 63/659,448, filed Jun. 13, 2024, the contents of which are incorporated herein by reference.

### TECHNICAL FIELD

The subject matter disclosed herein is generally directed to a cardiac defect model that can be used to instruct and train students in the medical field, such as nursing students.

### BACKGROUND

Nursing education is a dynamic field that continually seeks innovative approaches to effectively teach complex medical concepts and improve students' understanding of various healthcare conditions. One highly effective pedagogical tool in nursing education is the use of manipulatives. Often associated with early childhood education, manipulatives are hands-on tactile objects designed to facilitate active learning proven to improve student outcomes, increase long-term retention, and facilitate the conceptualization of complex medical conditions.

Congenital heart defects (CHDs) are one of the most common birth defects and affect nearly 1% of children born in the United States. These defects are especially challenging to pediatric nursing students due to their anatomical complexity and unique pathophysiology. Traditional teaching methods often rely on textbooks, two-dimensional illustrations, and didactic lectures, which can fail to engage active learning.

Three-dimensional (3D) printing is a technology based on digital image information that applies adhesive materials to construct customized objects layer by layer. Advancements in 3D printing have decreased the overall costs of 3D printers and filaments, making printing manipulatives affordable. A manipulative, such as a 3D-printed heart model, can aid pre-licensure nursing students in forming a lasting understanding of CHDs, enhance learning retention, and provide patients with quality care.

Nursing education has seen major technological advancements that provide immersive and effective learning experiences. However, the integration of 3D printing technology to create tailored CHD models for nursing students that are not currently commercially available has not been explored in depth.

Utilizing manipulatives as part of an interactive strategy can effectively teach nursing students, especially about topics students find complex and hard to understand. Compared to traditional lectures and case studies, using manipulatives advances overall understanding and knowledge retention. It also enhances students' ability to connect old and new information.

Manipulative learning activities increase students' engagement in learning when they have minimal understanding of the topic. These manipulative activities can build learning from the simple to the complex, making it possible for students to gain a broad knowledge of the concept topic. Utilizing manipulatives supports various learning styles, appealing to learners' visual, auditory, and kinesthetic needs.

Three-dimensional printed models can be effective educational tools for teaching the pathophysiology of CHDs to nursing students. Further, nursing students who utilize 3D printed models versus traditional teaching methods have statistically significant improvement in understanding anatomy, CHD nursing knowledge, and confidence in caring for children with CHDs. In one study, for example, cardiac nurses found that 3D printed CHD models improved their learning experience, and 74% agreed that the models were more useful than two-dimensional images.

A more realistic, detailed manipulative model is often thought to support learning better than a more simplistic manipulative. However, it has been found that a more detailed model does not improve learning. In fact, perceptual richness and detail can lead to decreased learning. Graphic details can be distracting to learners, whereas more abstract manipulatives enable students to grasp the underlying principles of the lesson.

As such, a need currently exists for an improved device for educating future and current healthcare professionals on various heart defects that includes multiple defects but that still promotes learning in a non-distracting, methodical way.

### SUMMARY

Aspects and advantages of embodiments of the present disclosure will be set forth in part in the following description, or can be learned from the description, or can be learned through practice of the embodiments.

In one aspect of the present disclosure, a cardiac defect model is provided. The cardiac defect model includes a base and a plurality of cavities. The base includes an aorta, a pulmonary artery, a left atrium, a right atrium, a left ventricle, and a right ventricle. The plurality of cavities are each configured to receive a normal cardiac component insert and a defective cardiac component insert. Further, the normal cardiac component insert and the defective cardiac component insert are interchangeable.

In another aspect, each of the plurality of cavities can include a protrusion. Further, each normal cardiac component insert and each defective cardiac component insert can include a protrusion that corresponds with the protrusion in each of the plurality of cavities.

In one more aspect, the cardiac defect model can include a first normal cardiac component insert and a first defective cardiac component insert. The first normal cardiac component insert and the first defective cardiac component insert can be triangular in shape. Further, the first defective cardiac component insert can include an opening between the aorta and the pulmonary artery and can illustrate a patent ductus arteriosus defect.

In yet another aspect, the cardiac defect model can include a second normal cardiac component insert and a second defective cardiac component insert. The second normal cardiac component insert and the second defective cardiac component insert cab be rectangular in shape. Further, the second defective cardiac component insert can include an opening between the left atrium and the right atrium and can illustrate an atrial septal defect.

In still another aspect, the cardiac defect can include a third normal cardiac component insert and a third defective cardiac component insert. The third normal cardiac component insert and the third defective cardiac component insert can be hexagonal in shape. Further, the third defective cardiac component insert can include a pulmonary valve that is stenotic and can illustrate a Tetralogy of Fallot defect.

In an additional aspect, the cardiac defect model can include a fourth normal cardiac component insert and a fourth defective cardiac component insert. The fourth defective cardiac component insert can include an opening between the left ventricle and the right ventricle. Further, the fourth defective cardiac component insert can be pentagonal in shape and can illustrate a ventral septal defect.

In one more aspect, the normal cardiac component insert can be a first color and the defective cardiac component insert can be a second color. In addition, the base can be a third color.

In further aspects, the base can be formed from a three-dimensional printed material, the normal cardiac component insert can be formed from a three-dimensional printed material, and/or the defective cardiac component inert can be formed from a three-dimensional printed material.

In another aspect, the cardiac defect model can be a pediatric cardiac defect model.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

A full and enabling disclosure of the present disclosure to one skilled in the art, including the best mode thereof, is set forth more particularly in the remainder of the specification, including reference to the accompanying figures, in which:

FIG. 1 is a bottom perspective view of the cardiac defect heart model base, with all cardiac defect heart model insertable parts removed;

FIG. 2 is the top plan view of the cardiac defect heart model base, with all cardiac defect heart model insertable parts removed;

FIG. 3 is a bottom perspective view of the cardiac defect heart model base, with all cardiac defect heart model insertable normal parts inserted;

FIG. 4 is the top plan view of the cardiac defect heart model base, with all cardiac defect heart model insertable normal parts inserted;

FIG. 5 is a bottom perspective view of all of the cardiac defect heart model insertable normal parts, removed from the cardiac defect heart model base;

FIG. 6 is a top perspective view of all of the cardiac defect heart model insertable normal parts, removed from the cardiac defect heart model base;

FIG. 7 is the top plan view of all of the cardiac defect heart model insertable normal parts, removed from the cardiac defect heart model base;

FIG. 8 is a bottom perspective view of all of the cardiac defect heart model insertable defective parts, removed from the cardiac defect heart model base;

FIG. 9 is a top perspective view of all of the cardiac defect heart model insertable defective parts, removed from the cardiac defect heart model base;

FIG. 10 is the top plan view of all of the cardiac defect heart model insertable defective parts, removed from the cardiac defect heart model base;

FIG. 11 is a bottom perspective view of the cardiac defect heart model base, with all cardiac defect heart model insertable defective parts inserted; and

FIG. 12 is the top plan view of the cardiac defect heart model base, with all cardiac defect heart model insertable defective parts inserted.

Repeat use of reference characters in the present specification and drawings is intended to represent the same or analogous features or elements of the present disclosure.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present disclosure. Any of the features, components, or details of any of the arrangements or embodiments disclosed in this application are interchangeably combinable with any other features, components, or details of any of the arrangements or embodiments disclosed herein to form new arrangements and embodiments.

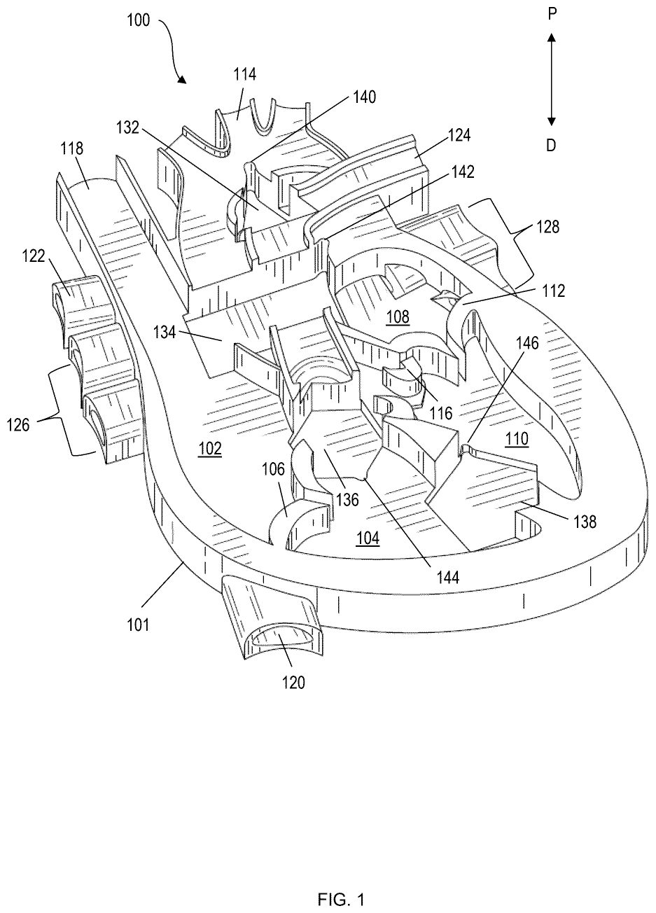

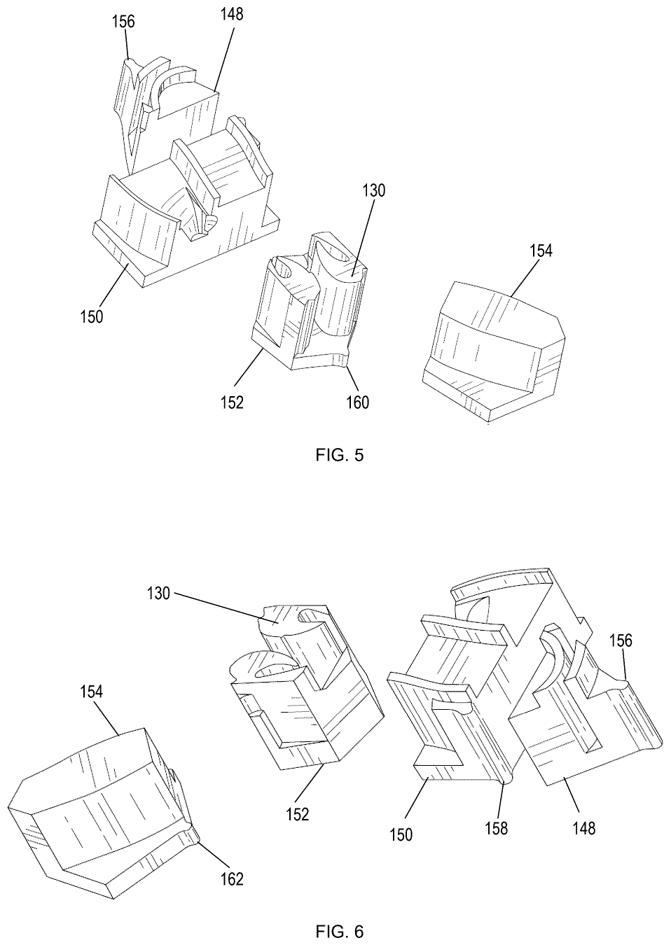

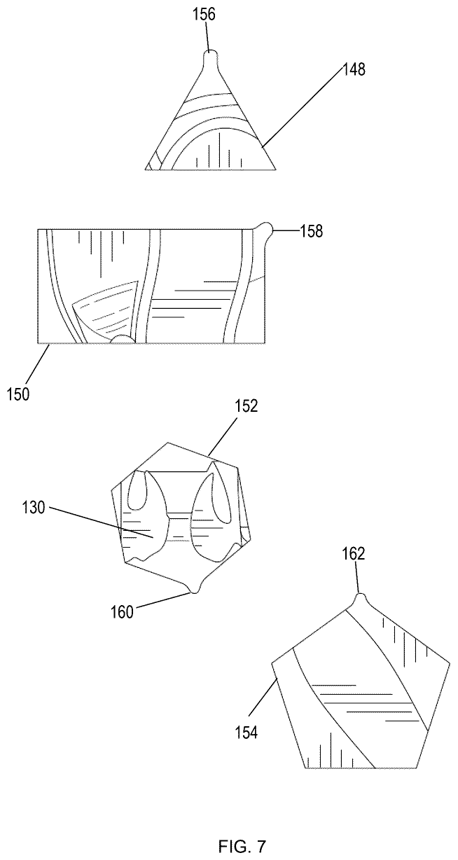

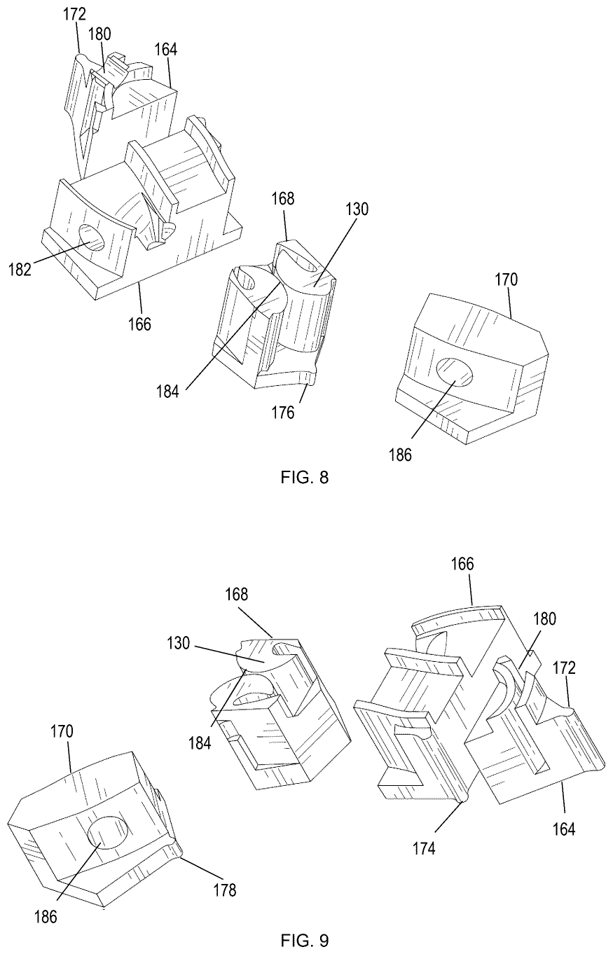

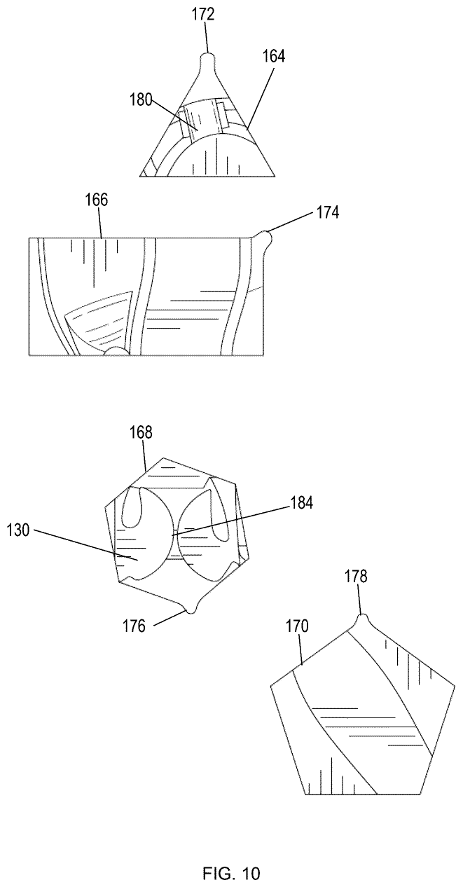

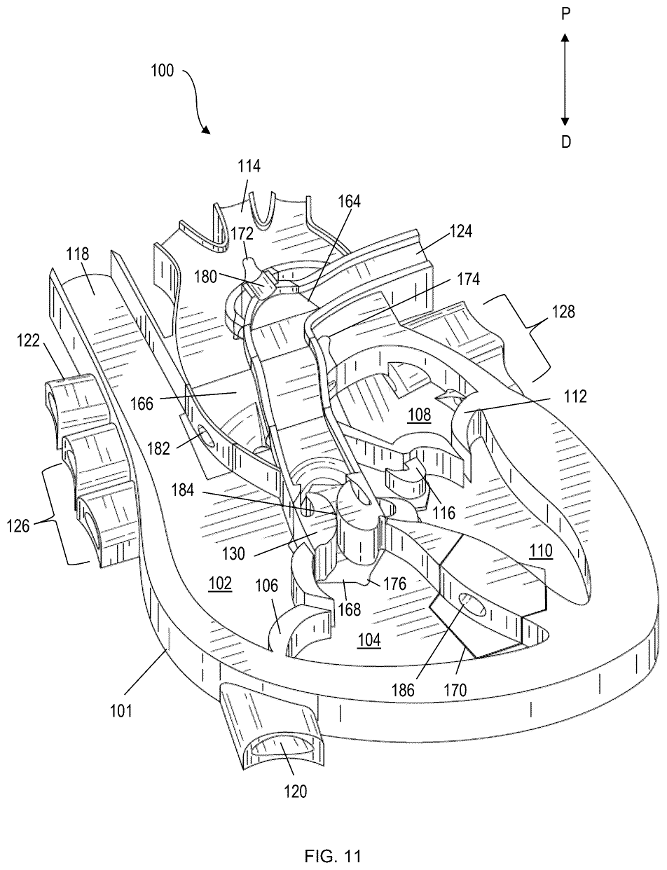

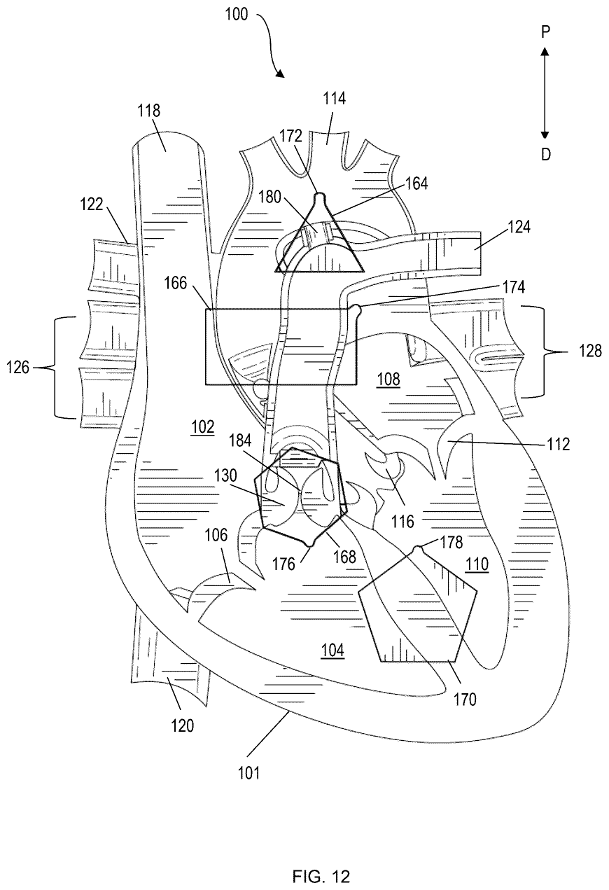

Generally speaking, the present disclosure is directed to a cardiac defect model that can be used for training and instruction purposes. For example, the cardiac defect model can be used to provide visual and tactile information to nursing students and other students in the medical field for comparison between normal cardiac structures and defective heart structures due to congenital heart defects, although it is to be understood that inserts including other types of defects are contemplated by the present disclosure. In one embodiment, the cardiac defect model includes a base that includes an aorta, a pulmonary artery, a left atrium, a right atrium, a left ventricle, and a right ventricle. The cardiac defect model also includes a plurality of cavities. Each cavity is configured to receive a normal cardiac component insert and a defective cardiac component insert. Further, the normal cardiac component insert and the defective cardiac component insert are interchangeable. By incorporating multiple types of defects in a single model, the learning opportunities for nursing students and other students in the medical field is enhanced, as oftentimes, if one defect is present in a patient, other defects are present as well. The various features that may be incorporated into the cardiac defect model of the present disclosure are discussed in more detail with respect to FIGS. 1-12.

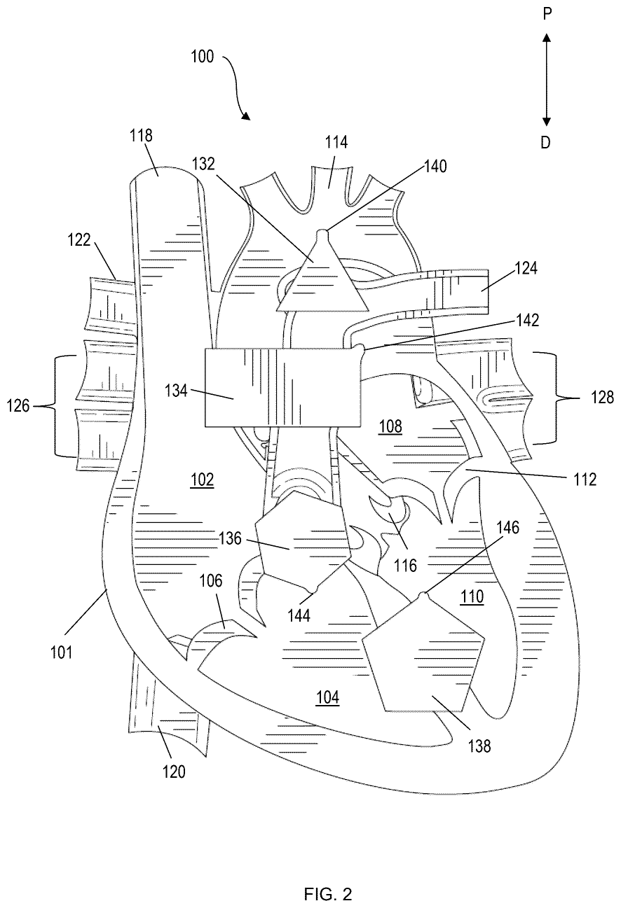

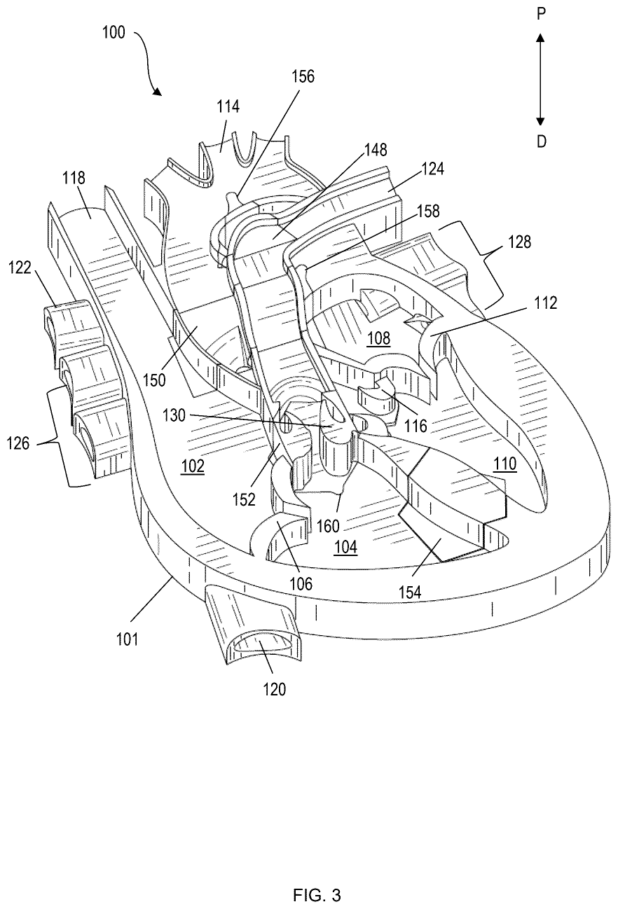

Turning first to FIGS. 1 and 2, a bottom perspective view and top plan view, respectively, of one embodiment of the cardiac defect heart model 100 of the present disclosure are illustrated. In FIGS. 1 and 2, all defective and normal cardiac component inserts have been removed, and the various inserts are discussed in detail with respect to FIGS. 3-12. As shown in FIGS. 1 and 2, the cardiac defect heart model 100 includes a base 101. Working from the proximal end P of the cardiac defect heart model 100 to the distal end D of the cardiac defect model 100, the base 101 includes a right atrium 102 and a right ventricle 104, with a tricuspid valve 106 separating the chambers on the right side of the cardiac defect heart model 100. Also working from the proximal end P of the cardiac defect heart model 100 to the distal end D of the cardiac defect model 100, the base 101 also includes a left atrium 108 and a left ventricle 110, with a mitral valve 112 separating the chambers on the left side of the cardiac defect model 100. The cardiac defect heart model 100 also includes an aorta 114 and an aortic valve 116 that regulates blood flow from the heart's left ventricle 110 to the aorta 114, which is the main artery carrying blood to the rest of the body.

Still referring to FIGS. 1 and 2, the cardiac defect model 100 can also include a superior vena cava 118 and an inferior vena cava 120, which serve to carry deoxygenated blood from the body back to the heart, as well as a right pulmonary artery 122 and a left pulmonary artery 124, which supply the deoxygenated blood to the right lung and left lung, respectively. Further, the cardiac defect model 100 can also include branches of the right pulmonary vein 126 and branches of the left pulmonary vein 128, which supply oxygenated blood from the lungs to the heart. The cardiac defect model 100 also includes a pulmonary valve 130 (see FIG. 3) that is located between the right ventricle 104 and the left pulmonary artery 124, which helps to control the flow of deoxygenated blood from the heart to the lungs for oxygenation.

As shown in FIGS. 1 and 2, the cardiac defect model 100 contemplated by the present disclosure includes a plurality of cavities, such as first cavity 132, second cavity 134, third cavity 136, and fourth cavity 138. These cavities are configured to receive the normal cardiac component inserts and the defective cardiac component inserts discussed in more detail with respect to FIGS. 3-7 and FIGS. 8-12, respectively. Each of the cavities includes a protrusion that corresponds with a protrusion in the normal cardiac component inserts and the defective cardiac component inserts to ensure that the inserts are placed in the appropriate position during use for training on the various cardiac structures that may include normal anatomy or defects. For instance, first cavity 132 has a first protrusion 140, second cavity 134 has a second protrusion 142, third cavity 136 has a third protrusion 144, and fourth cavity 138 has a fourth protrusion 146. Although protrusions are shown, any suitably shaped protrusion can be used so long as the normal cardiac component inserts and the defective cardiac component inserts have a corresponding protrusion that aligns with each protrusion to facilitate proper placement of each insert. Further, although four cavities are shown, it is to be understood that any number of cavities can be utilized that correspond to inserts to show numerous normal anatomical structures of the heart as well as numerous defective anatomical structures of the heart.

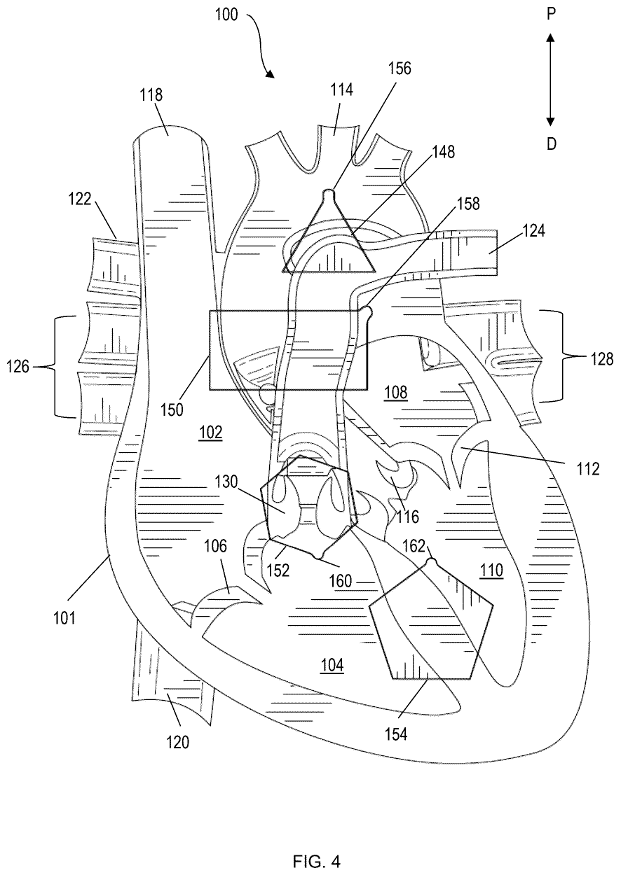

Turning now to FIG. 3, a bottom perspective view of the cardiac defect heart model 100 with all cardiac defect heart model insertable normal parts inserted is shown. Meanwhile, FIG. 4 shows the top plan view of the cardiac defect heart model 100, with all cardiac defect heart model insertable normal parts inserted. Working from the proximal end P of the cardiac defect heart model 100 to the distal end D of the cardiac defect model 100, the base 101 includes a first normal cardiac component insert 148 that is insertable into the first cavity 132, a second normal cardiac component insert 150 that is insertable into the second cavity 134, a third normal cardiac component insert 152 that is insertable into the third cavity 136, and a fourth normal cardiac component insert 154 that is insertable into the fourth cavity 138 (see FIGS. 1 and 2). Each of the normal cardiac component inserts includes a protrusion that corresponds with the protrusions present in each cavity discussed above with respect to FIGS. 1 and 2 to ensure that the inserts are placed in the appropriate position during use for training on the various cardiac structures represented by the cardiac defect heart model 100.

Referring to FIGS. 3 through 7, the first normal cardiac component insert 148 can be triangular in shape and can show a normal configuration between the aorta 114 and a portion of the pulmonary artery, such as the left pulmonary artery 124. The first normal cardiac component insert 148 can include a first protrusion 156 that can be located at the apex of the triangular shape of the first normal cardiac component insert 148, where the first protrusion 156 can correspond with the first protrusion 140 of the first cavity 132. However, it is also to be understood that the first protrusion 156 can be located at any other location around the border of the triangular shape, such as along the base or vertices of the triangular shape in other embodiments.

Still referring to FIGS. 3 through 7, the second normal cardiac component insert 150 can be rectangular in shape and can show a normal configuration between the left atrium 108 and the right atrium 102. The second normal cardiac component insert 150 can include a second protrusion 158 that can be located at a corner of the rectangular shape of the second normal cardiac component insert 150, where the second protrusion 158 can correspond with the second protrusion 142 of the second cavity 134. However, it is also to be understood that the second protrusion 158 can be located at any other location around the border of the rectangular shape, such as along any of the sides or at the other corners of the rectangular shape.

Referring again to FIGS. 3 through 7, the third normal cardiac component insert 152 can be hexagonal in shape and can show a normal configuration of the pulmonary valve 130. The third normal cardiac component insert 152 can include a third protrusion 160 that can be located at a bottom corner of the hexagonal shape of the third normal cardiac component insert 152, where the third protrusion 160 can correspond with the third protrusion 144 of the third cavity 136. However, it is also to be understood that the third protrusion 160 can be located at any other location around the border of the hexagonal shape, such as along any of the sides or at the other corners of the hexagonal shape.

Also referring to FIGS. 3 through 7, the fourth normal cardiac component insert 154 can be pentagonal in shape and can show a normal configuration between the right ventricle 104 and the left ventricle 110. The fourth normal cardiac component insert 154 can include a fourth protrusion 162 that can be located at a top corner of the pentagonal shape of the fourth normal cardiac component insert 154, where the fourth protrusion 162 can correspond with the fourth protrusion 146 of the fourth cavity 138. However, it is also to be understood that the fourth protrusion 162 can be located at any other location around the border of the pentagonal shape, such as along any of the sides or at the other corners of the pentagonal shape.

The normal cardiac component inserts discussed above can be used to educate nursing students and other students in the medical field regarding the normal, healthy anatomy of a pediatric patient. The present disclosure also contemplates interchanging the normal cardiac components with one or more defective cardiac components in order train students on, for example, congenital defects that may impact pediatric patients.

Referring now to FIGS. 8 through 12, some of the various defects contemplated by the present disclosure are discussed in detail. For instance, the first defective cardiac component insert 164 can be triangular in shape and can include a first defect 180 located between the aorta 114 and a portion of the pulmonary artery, such as the left pulmonary artery 124. Further, the first defective cardiac component insert 164 can include a first protrusion 172 that can be located at the apex of the triangular shape of the first normal cardiac component insert 148, where the first protrusion 156 can correspond with the first protrusion 140 of the first cavity 132. However, it is also to be understood that the first protrusion 156 can be located at any other location around the border of the triangular shape, such as along the base or vertices of the triangular shape in other embodiments.

More specifically, the first defect 180 can be a patent ductus arteriosus. A patent ductus arteriosus is an abnormal opening between the aorta 114 and pulmonary artery, such as the left pulmonary artery 124. Typically, when in the womb, a baby's blood goes around his or her lungs through a normal opening call ed a ductus arteriosus, which allows the baby to get oxygen from his or her mother's blood. Shortly after birth, the ductus arteriosus closes on its own so blood can go to the lungs to get oxygen, but when the ductus arteriosus does not close on its own as it should, it is a called a patent or open ductus arteriosus, as exemplified by defect 180 in the first defective cardiac component insert 164.

Referring still to FIGS. 8 through 12, the second defective cardiac component insert 166 can be rectangular in shape and can include a second defect 182 between the left atrium 108 and the right atrium 102. The second defective cardiac component insert 166 can include a second protrusion 174 that can be located at a corner of the rectangular shape of the second defective cardiac component insert 166, where the second protrusion 174 can correspond with the second protrusion 142 of the second cavity 134. However, it is also to be understood that the second protrusion 174 can be located at any other location around the border of the rectangular shape, such as along any of the sides or at the other corners of the rectangular shape.

More specifically, the second defect 182 can be an atrial septal defect, which refers to the presence of a hole or opening between the right atrium 102 and the left atrium 108. This hole or opening that results in the second defect 182 increases the amount of blood going through the lungs.

As further shown in FIGS. 8 through 12, the third defective cardiac component insert 168 can be hexagonal in shape and can show an abnormal configuration of the pulmonary valve 130, resulting in third defect 184. The third defective cardiac component insert 168 can include a third protrusion 176 that can be located at a bottom corner of the hexagonal shape of the third defective cardiac component insert 168, where the third protrusion 176 can correspond with the third protrusion 144 of the third cavity 136. However, it is also to be understood that the third protrusion 176 can be located at any other location around the border of the hexagonal shape, such as along any of the sides or at the other corners of the hexagonal shape.

The third defect 184 is exemplified by a stenotic pulmonary valve 130, which results in reduced blood flow from the right ventricle 104 to the right and left pulmonary arteries 122 and/or 124, due to the narrowing of the pulmonary valve 130 and/or a thickening of the tissue at the pulmonary valve 130. Such a defect can be associated with a defect termed tetralogy of Fallot, resulting in altered blood flow through the heart and the rest of the body.

Referring still to FIGS. 8 through 12, the fourth defective cardiac component insert 170 can be pentagonal in shape and can show an abnormal configuration between the right ventricle 104 and the left ventricle 110, resulting in a fourth defect 186. The fourth defective cardiac component insert 170 can include a fourth protrusion 178 that can be located at a top corner of the pentagonal shape of the fourth defective cardiac component insert 170, where the fourth protrusion 178 can correspond with the fourth protrusion 146 of the fourth cavity 138. However, it is also to be understood that the fourth protrusion 178 can be located at any other location around the border of the pentagonal shape, such as along any of the sides or at the other corners of the pentagonal shape.

More specifically, the fourth defect 186 can be a ventral septal defect, which refers to the presence of a hole or opening between the right ventricle 104 and the left ventricle 110. This hole or opening that results in the fourth defect 186 changes how the blood flows through the heart and lungs, where oxygen-rich blood gets pumped back to the lungs instead of out to the body.

The base 101 and various normal and defective cardiac component inserts discussed above that form the cardiac defect model 100 of the present disclosure can be formed from any suitable material, including plastic, rubber, silicone, composites, and the like. In one particular embodiment, the base 101 and various inserts can be formed by three-dimensional printing of a three-dimensional printed material to provide an economical way to provide the cardiac defect model 100 to a number of students. Example three-dimensional printed materials include but are not limited to polylactic acid, acrylonitrile butadiene styrene, polyethylene terephthalate glycol, thermoplastic polyurethane, nylon, polycarbonate, PEEK, or a combination thereof.

Further, the base 101, normal cardiac component inserts, and defective cardiac component inserts can be formed from different colors to create contrast to allow for easier distinction between normal and defective parts. For instance, the base can be red, the normal cardiac component parts can be white, and the defective cardiac component parts can be blue. However, once a student becomes comfortable with the inserts when they are different colors, the same color could be used for the normal and defective cardiac component inserts and/or base to create a more challenging environment to further test the students' knowledge.

While various embodiments of the present disclosure have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the present disclosure, but instead as merely intended to highlight alternative or additional features that may or may not be utilized in a particular embodiment of the present disclosure. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments. For instance, when a plurality of ranges are provided, any combination of a minimum value and a maximum value described in the plurality of ranges are contemplated by the present disclosure. For example, if ranges of ‘from about 20% to about 80%’ and ‘from about 30% to about 70%’ are described, a range of ‘from about 20% to about 70%’ or a range of ‘from about 30% to about 80%’ are also contemplated by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article ‘a’ or ‘an’ does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases ‘at least one’ and ‘one or more’ to introduce claim recitations. However, the use of such phrases should not be construed to imply that the introduction of a claim recitation by the indefinite articles ‘a’ or ‘an’ limits any particular claim containing such introduced claim recitation to embodiments containing only one such recitation, even when the same claim includes the introductory phrases ‘one or more” or ‘at least one’ and indefinite articles such as ‘a’ or ‘an’ (e.g., ‘a’ and/or ‘an’ should typically be interpreted to mean ‘at least one’ or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of ‘two recitations,’ without other modifiers, typically means at least two recitations, or two or more recitations). Furthermore, in those instances where a convention analogous to ‘at least one of A, B, and C, etc.’ is used, in general such a construction is intended in the sense one having skill in the art would understand the convention (e.g., ‘a system having at least one of A, B, and C’ would include but not be limited to systems that have A alone, B alone, C alone, A and B together, A and C together, B and C together, and/or A, B, and C together, etc.). In those instances where a convention analogous to ‘at least one of A, B, or C, etc.’ is used, in general such a construction is intended in the sense one having skill in the art would understand the convention (e.g., ‘a system having at least one of A, B, or C’ would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase ‘A or B’ will be understood to include the possibilities of ‘A’ or ‘B’ or ‘A and B.’

All numbers expressing quantities of ingredients, reaction conditions, and so forth used in the specification are to be understood as being modified in all instances by the terms ‘about,’ ‘approximately,’ or ‘generally.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches. As used herein, the terms ‘about,’ ‘approximately,’ or ‘generally,’ when used to modify a value, indicate that the value can be raised or lowered by 5% and remain within the disclosed embodiment.

All of the features disclosed in this specification (including any accompanying exhibits, claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A cardiac defect model comprising:
a base comprising an aorta, a pulmonary artery, a left atrium, a right atrium, a left ventricle, and a right ventricle; and
a plurality of cavities each configured to receive a normal cardiac component insert and a defective cardiac component insert, wherein the normal cardiac component insert and the defective cardiac component insert are interchangeable.

2. The cardiac defect model of claim 1, wherein each of the plurality of cavities includes a protrusion.

3. The cardiac defect model of claim 2, wherein each normal cardiac component insert and each defective cardiac component insert include a protrusion that corresponds with the protrusion in each of the plurality of cavities.

4. The cardiac defect model of claim 1, comprising a first normal cardiac component insert and a first defective cardiac component insert, wherein the first normal cardiac component insert and the first defective cardiac component insert are triangular in shape.

5. The cardiac defect model of claim 4, wherein the first defective cardiac component insert includes an opening between the aorta and the pulmonary artery.

6. The cardiac defect model of claim 4, wherein the first defective cardiac component insert illustrates a patent ductus arteriosus defect.

7. The cardiac defect model of claim 1, comprising a second normal cardiac component insert and a second defective cardiac component insert, wherein the second normal cardiac component insert and the second defective cardiac component insert are rectangular in shape.

8. The cardiac defect model of claim 7, wherein the second defective cardiac component insert includes an opening between the left atrium and the right atrium.

9. The cardiac defect model of claim 7, wherein the second defective cardiac component insert illustrates an atrial septal defect.

10. The cardiac defect model of claim 1, comprising a third normal cardiac component insert and a third defective cardiac component insert, wherein the third normal cardiac component insert and the third defective cardiac component insert are hexagonal in shape.

11. The cardiac defect model of claim 10, wherein the third defective cardiac component insert includes a pulmonary valve, wherein the pulmonary valve is stenotic.

12. The cardiac defect model of claim 10, wherein the third defective cardiac component insert illustrates a Tetralogy of Fallot defect.

13. The cardiac defect model of claim 1, comprising a fourth normal cardiac component insert and a fourth defective cardiac component insert, wherein the fourth normal cardiac component insert and the fourth defective cardiac component insert are pentagonal in shape.

14. The cardiac defect model of claim 13, wherein the fourth defective cardiac component insert includes an opening between the left ventricle and the right ventricle.

15. The cardiac defect model of claim 13, wherein the fourth defective cardiac component insert illustrates a ventral septal defect.

16. The cardiac defect model of claim 1, wherein the normal cardiac component insert is a first color and the defective cardiac component insert is a second color.

17. The cardiac defect model of claim 16, wherein the base is a third color.

18. The cardiac defect model of claim 1, wherein the base is formed from a three-dimensional printed material.

19. The cardiac defect model of claim 1, wherein the normal cardiac component insert, the defective cardiac component insert, or both are formed from a three-dimensional printed material.

20. The cardiac defect model of claim 1, wherein the cardiac defect model is a pediatric cardiac defect model.
